(19) United States
(12) Patent Application Publication
(10) Pub. No.: US 2021/0364368 A1
(43) Pub. Date: Nov. 25, 2021

(54) TEMPERATURE SENSOR ELEMENT

(71) Applicant: SUMITOMO CHEMICAL COMPANY, LIMITED, Tokyo (JP)

(72) Inventors: Megumi HAYASAKA, Osaka-shi (JP); Yuichiro KUNAI, Toyonaka-shi (JP)

(73) Assignee: SUMITOMO CHEMICAL COMPANY, LIMITED, Tokyo (JP)

(21) Appl. No.: 17/419,658

(22) PCT Filed: Mar. 4, 2020
(86) PCT No.: PCT/JP2020/009082

§ 371 Date: Jun. 29, 2021

(30) Foreign Application Priority Data
Mar. 29, 2019 (JP) 2019-068127

(51) Int. Cl. G01K 7/22; C08L 79/08

(52) U.S. Cl. CPC G01K 7/223; C08L 2203/20; C08L 79/08

(57) ABSTRACT

There is provided a temperature sensor element including a pair of electrodes and a temperature-sensitive film disposed in contact with the pair of electrodes, in which the temperature-sensitive film includes a conductive polymer, the conductive polymer includes a conjugated polymer and a dopant, and the dopant includes a dopant having a molecular volume of 0.08 nm³ or more.

### TECHNICAL FIELD

The present invention relates to a temperature sensor element.

### BACKGROUND ART

There has been conventionally known a thermistor-type temperature sensor element including a temperature-sensitive film changed in electric resistance value (also referred to as “instruction value”) due to the change in temperature. An inorganic semiconductor thermistor has been conventionally used in the temperature-sensitive film of such a thermistor-type temperature sensor element. Such an inorganic semiconductor thermistor is hard, and thus a temperature sensor element using the same is usually difficult to have flexibility.

Japanese Patent Laid-Open No. H3-255923 (Patent Literature 1) relates to a thermistor-type infrared detection element using a polymer semiconductor having NTC characteristics (Negative Temperature Coefficient; characteristics of the reduction in electric resistance value due to the rise in temperature). The infrared detection element detects infrared light by detecting the rise in temperature due to incident infrared light, in terms of the change in electric resistance value, and includes a pair of electrodes and a thin film including the polymer semiconductor containing an electronically conjugated organic polymer partially doped, as a component.

### CITATION LIST

### Patent Literature

Patent Literature 1: Japanese Patent Laid-Open No. H3-255923

### SUMMARY OF INVENTION

### Technical Problem

The thin film in the infrared detection element disclosed in Patent Literature 1 is formed by an organic substance, and thus flexibility can be imparted to the infrared detection element.

However, there is not considered about repeating stability of the electric resistance value exhibited by the temperature sensor element.

The repeating stability of the electric resistance value means an ability where, even in a case where the temperature of an object (for example, environment) to be measured by the temperature sensor element is varied, the same electric resistance value as the electric resistance value exhibited at the initial temperature can be exhibited when the temperature of the object reaches the same temperature as the initial temperature. In a case where, when the temperature of the object to be measured is changed and then reaches the same temperature as the initial temperature, the same electric resistance value as the electric resistance value exhibited at the initial temperature is exhibited or the difference in numerical value between these electric resistance values is small, even if occurs, the temperature sensor element can be said to be excellent in repeating stability of the electric resistance value.

An object of the present invention is to provide a thermistor-type temperature sensor element including a temperature-sensitive film including an organic substance, in which the temperature sensor element is excellent in repeating stability of the electric resistance value.

### Solution to Problem

The present invention provides the following temperature sensor element.

[1] A temperature sensor element including a pair of electrodes and a temperature-sensitive film disposed in contact with the pair of electrodes, wherein
the temperature-sensitive film includes a conductive polymer,
the conductive polymer includes a conjugated polymer and a dopant, and the dopant includes a dopant having a molecular volume of 0.08 nm³ or more.

[2] The temperature sensor element according to [1], wherein the temperature-sensitive film includes a matrix resin and a plurality of conductive domains contained in the matrix resin, and
the conductive domains include the conductive polymer.

[3] The temperature sensor element according to [2], wherein the matrix resin includes a polyimide-based resin.

[4] The temperature sensor element according to [3], wherein the polyimide-based resin includes an aromatic ring.

[5] The temperature sensor element according to any of [1] to [4], wherein the conjugated polymer is a polyaniline-based polymer.

### Advantageous Effect of Invention

There can be provided a temperature sensor element excellent in repeating stability of an electric resistance value.

### BRIEF DESCRIPTION OF DRAWINGS

FIG. 1 is a schematic top view illustrating one example of the temperature sensor element according to the present invention.

FIG. 2 is a schematic cross-sectional view illustrating one example of the temperature sensor element according to the present invention.

FIG. 3 is a schematic top view illustrating a method of producing a temperature sensor element of Example 1.

FIG. 4 is a schematic top view illustrating the method of producing the temperature sensor element of Example 1.

FIG. 5 is a SEM photograph of a temperature-sensitive film included in the temperature sensor element of Example 1.

### DESCRIPTION OF EMBODIMENTS

The temperature sensor element according to the present invention (hereinafter, also simply referred to as “temperature sensor element”.) includes a pair of electrodes and a temperature-sensitive film disposed in contact with the pair of electrodes.

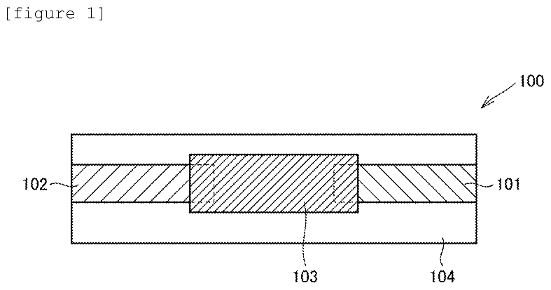

FIG. 1 is a schematic top view illustrating one example of the temperature sensor element. A temperature sensor element 100 illustrated in FIG. 1 includes a pair of electrodes of a first electrode 101 and a second electrode 102, and a temperature-sensitive film 103 disposed in contact with both the first electrode 101 and the second electrode 102. The temperature-sensitive film 103, both ends of which are formed on the first electrode 101 and the second electrode 102, respectively, is thus in contact with such electrodes.

The temperature sensor element can further include a substrate 104 that supports the first electrode 101, the second electrode 102 and the temperature-sensitive film 103 (see FIG. 1).

The temperature sensor element 100 illustrated in FIG. 1 is a thermistor-type temperature sensor element where the temperature-sensitive film 103 detects the change in temperature, as an electric resistance value.

The temperature-sensitive film 103 has NTC characteristics that exhibit a decrease in electric resistance value due to the rise in temperature.

[1] First Electrode and Second Electrode

The first electrode 101 and the second electrode 102 here used are sufficiently small in electric resistance value as compared with the temperature-sensitive film 103. The respective electric resistance values of the first electrode 101 and the second electrode 102 included in the temperature sensor element are specifically preferably 500Ω or less, more preferably 200Ω or less, further preferably 100Ω or less at a temperature of 25° C.

The respective materials of the first electrode 101 and the second electrode 102 are not particularly limited as long as a sufficiently small electric resistance value is obtained as compared with that of the temperature-sensitive film 103, and such each material can be, for example, a metal single substance such as gold, silver, copper, platinum, or palladium; an alloy including two or more metal materials; a metal oxide such as indium tin oxide (ITO) or indium zinc oxide (IZO); or a conductive organic substance (for example, a conductive polymer).

The material of the first electrode 101 and the material of the second electrode 102 may be the same as or different from each other.

The respective methods of forming the first electrode 101 and the second electrode 102 are not particularly limited, and may be each a common method such as vapor deposition, sputtering, or coating (coating method). The first electrode 101 and the second electrode 102 can be each formed directly on the substrate 104.

The respective thicknesses of the first electrode 101 and the second electrode 102 are not particularly limited as long as a sufficiently small electric resistance value is obtained as compared with that of the temperature-sensitive film 103, and such each thickness is, for example, 50 nm or more and 1000 nm or less, preferably 100 nm or more and 500 nm or less.

[2] Substrate

The substrate 104 is a support that supports the first electrode 101, the second electrode 102 and the temperature-sensitive film 103.

The material of the substrate 104 is not particularly limited as long as the material is non-conductive (insulating), and the material can be, for example, a resin material such as a thermoplastic resin or an inorganic material such as glass. In a case where a resin material is used in the substrate 104, the temperature-sensitive film 103 typically has flexibility and thus flexibility can be imparted to the temperature sensor element.

The thickness of the substrate 104 is preferably set in consideration of flexibility, durability, and the like of the temperature sensor element. The thickness of the substrate 104 is, for example, 10 μm or more and 5000 μm or less, preferably 50 μm or more and 1000 μm or less.

[3] Temperature-Sensitive Film

The temperature-sensitive film includes a conductive polymer. The conductive polymer includes a conjugated polymer and a dopant, and is preferably a conjugated polymer doped with a dopant.

The temperature-sensitive film may be formed from only the conductive polymer, or may include the conductive polymer and a matrix resin.

The temperature-sensitive film preferably includes a matrix resin and the conductive polymer, more preferably includes a matrix resin and a plurality of conductive domains that are dispersed in the matrix resin and that include the conductive polymer, from the viewpoint of an enhancement in repeating stability of the electric resistance value.

[3-1] Conductive Polymer

The conductive polymer includes a conjugated polymer and a dopant, and is preferably a conjugated polymer doped with a dopant.

A conjugated polymer by itself is usually extremely low in electric conductivity, and exhibits almost no electric conducting properties, for example, which correspond to 1×10⁻⁶ S/m or less. The reason why a conjugated polymer by itself is low in electric conductivity is because the valance band is saturated with electrons and such electrons cannot be freely transferred. On the other hand, a conjugated polymer, in which electrons are delocalized, is thus remarkably low in ionization potential and very large in electron affinity as compared with a saturated polymer. Accordingly, a conjugated polymer easily allows charge transfer with an appropriate dopant such as an electron acceptor (acceptor) or an electron donor (donor) to occur, and such a dopant can withdraw an electron from the valance band of such a conjugated polymer or inject an electron to the conduction band thereof. Thus, such a conjugated polymer doped with a dopant, namely, the conductive polymer can have a few holes present in the valance band or a few electrons present in the conduction band to allow such holes and/or electrons to be freely transferred, and thus tends to be drastically enhanced in conductive properties.

The conjugated polymer forming the conductive polymer preferably has a value of linear resistance R in the range of 0.01Ω or more and 300 MΩ or less at a temperature of 25° C., as measured with an electric tester at a distance between lead bars of several mm to several cm. The conjugated polymer is one having a conjugated structure in its molecule, and examples include a molecule having a backbone where a double bond and a single bond are alternately linked, and a polymer having an unshared pair of electrons conjugated. Such a conjugated polymer can easily impart electric conducting properties by doping, as described above. The conjugated polymer is not particularly limited, and examples thereof include polyacetylene; poly(p-phenylenevinylene); polypyrrole; polythiophene-based polymers such as poly(3,4-ethylenedioxythiophene) [PEDOT]; and polyaniline-based polymers. The polythiophene-based polymer here means, for example, polythiophene, a polymer having a polythiophene backbone and having a side chain into which a substituent is introduced, and a polythiophene derivative. The “-based polymer” mentioned herein means a similar molecule.

The conjugated polymer may be used singly or in combinations of two or more kinds thereof.

The conjugated polymer is preferably a polyaniline-based polymer from the viewpoint of easiness of polymerization and identification.

Examples of the dopant include a compound serving as an electron acceptor (acceptor) from the conjugated polymer and a compound serving as an electron donor (donor) to the conjugated polymer.

The conductive polymer included in the temperature-sensitive film of the temperature sensor element according to the present invention includes a dopant having a molecular volume of 0.08 nm³ or more. The conductive polymer may include only a dopant having a molecular volume of 0.08 nm³ or more, or may include two or more such dopants. Thus, the temperature sensor element can be enhanced in repeating stability of the electric resistance value. Even in a case where the temperature sensor element is used for a long time or in a case where the temperature of an object (for example, environment) to be measured by the temperature sensor element is varied, the temperature sensor element can exhibit an electric resistance value favorable in reproducibility.

One reason for an enhancement in repeating stability of the electric resistance value of the temperature sensor element due to inclusion of a dopant having a molecular volume of 0.08 nm³ or more in the conductive polymer is presumed because the dopant is hardly desorbed from the conjugated polymer. In a case where the conjugated polymer has the above molecular volume, desorption is considered to be hardly made by, for example, the structure or steric hindrance of the dopant.

The molecular volume of the dopant included in the conductive polymer is preferably 0.10 nm³ or more, more preferably 0.15 nm³ or more, further preferably 0.18 nm³ or more, extremely preferably 0.22 nm³ or more, extremely further preferably 0.24 nm³ or more, from the viewpoint of an enhancement in repeating stability of the electric resistance value.

The molecular volume of the dopant included in the conductive polymer is usually 1 nm³ or less, preferably 0.8 nm³ or less, more preferably 0.5 nm³ or less. The dopant can have such a molecular volume, thereby allowing doping to more progress and allowing the variation in rate of doping to be suppressed.

The molecular volume of the dopant is changed depending on the size of any atom constituting the dopant, the steric structure, and/or the like.

The conductive polymer can include not only a dopant having a molecular volume of 0.08 nm³ or more, but also a dopant having a molecular volume of less than 0.08 nm³. However, the conductive polymer preferably includes only a dopant having a molecular volume of 0.08 nm³ or more from the viewpoint of an enhancement in repeating stability of the electric resistance value.

The molecular volume of the dopant can be determined based on the molecular structure, according to DFT (Density Functional Theory; B3LYP/6-31G) calculation using common calculation software. Examples of such calculation software include a quantum chemistry calculation program “Gaussian series” manufactured by Hulinks Inc.

The dopant included in the conductive polymer is preferably high in boiling point from the viewpoint that desorption from the conjugated polymer is suppressed to suppress deterioration in repeating stability of the electric resistance value. The boiling point of the dopant at atmospheric pressure is preferably 100° C. or more, more preferably 150° C. or more, further preferably 200° C. or more.

In a case where the conductive polymer includes two or more dopants, at least one thereof preferably has a boiling point in the above range, and all the dopants more preferably each have a boiling point in the above range.

The dopant having a molecular volume of 0.08 nm³ or more may be a compound serving as an acceptor from the conjugated polymer or a compound serving as a donor to the conjugated polymer, as described above.

A preferable example of the dopant having a molecular volume of 0.08 nm³ or more and serving as the acceptor is an organic compound, and, in particular, an organic acid is preferably used in a case where the conjugated polymer is a polyaniline-based polymer. In a case where the conjugated polymer is a polyaniline-based polymer, an organic acid is low in proton donating ability and thus the polyaniline-based polymer tends to be hardly oxidatively decomposed to improve long-term stability of the temperature-sensitive film.

Examples of the organic acid include 2-(2-pyridyl)ethanesulfonic acid, isoquinoline-5-sulfonic acid, nonafluoro-1-butanesulfonic acid, m-toluidine-4-sulfonic acid, 3-aminobenzenesulfonic acid, 3-amino-4-methylbenzenesulfonic acid, styrenesulfonic acid, toluenesulfonic acid, phenolsulfonic acid, cresolsulfonic acid, 2-naphthalenesulfonic acid, 5-amino-2-naphthalenesulfonic acid, 8-amino-2-naphthalenesulfonic acid, anthraquinone-2-sulfonic acid, anthraquinone-1-sulfonic acid, anthraquinone-2,6-disulfonic acid, 2-methylanthraquinone-6-sulfonic acid, poly(4-styrenesulfonic acid), 2-methacryloyloxyethyl acid phosphate, and 2-acryloyloxyethyl acid phosphate.

A preferable example of the dopant having a molecular volume of 0.08 nm³ or more and serving as the donor is an alkylamine, and the alkylamine may be linear or branched. The alkylamine is preferably an alkylamine where the number of carbon atoms of an alkyl group as a main chain is 3 or more.

Examples of the dopant serving as the donor include tributylamine, triisoamylamine, trihexylamine, triheptylamine, triamylamine, tri-n-decylamine, tris(2-ethylhexyl) amine, trinonylamine, and triundecylamine.

One preferable example of the conductive polymer is one where the conjugated polymer is a polyaniline-based polymer and the dopant has a molecular volume of 0.08 nm³ or more and serves as the acceptor.

Another preferable example of the conductive polymer is one where the conjugated polymer is a polyaniline-based polymer and the dopant has a molecular volume of 0.08 nm³ or more and is an organic acid serving as the acceptor.

The content of the dopant in the temperature-sensitive film 103 is preferably 1% by mass or more, more preferably 3% by mass or more relative to the temperature-sensitive film, from the viewpoint of conductive properties of the conductive polymer. The content is preferably 60% by mass or less, more preferably 50% by mass or less relative to the temperature-sensitive film.

The content of the dopant is preferably 0.1 mol or more, more preferably 0.4 mol or more based on 1 mol of the conjugated polymer. The content is preferably 3 mol or less, more preferably 2 mol or less based on 1 mol of the conjugated polymer.

The electric conductivity of the conductive polymer is obtained by combining the electronic conductivity in a molecular chain, the electronic conductivity between molecular chains, and the electronic conductivity between fibrils.

Carrier transfer is generally described by a hopping conduction mechanism. An electron present at a localized level in a non-crystalline region can be jumped to an adjacent localized level by the tunneling effect, in a case where the distance between localized states is short. In a case where there is a difference in energy between localized states, a thermal excitation process depending on the difference in energy is required. The conduction due to tunneling with such a thermal excitation process corresponds to hopping conduction.

In a case where the density of states is high at a low temperature or in the vicinity of the Fermi level, hopping to a distal level, small in difference in energy, is more dominant than hopping to a proximal level, large in difference in energy. In such a case, a variable range hopping conduction model (Mott-VRH model) is applied.

As can be understood from a variable range hopping conduction model (Mott-VRH model), the conductive polymer has NTC characteristics that exhibit a decrease in electric resistance value due to the rise in temperature.

[3-2] Matrix Resin

The temperature-sensitive film preferably includes a conductive polymer and a matrix resin, more preferably includes a matrix resin and a plurality of conductive domains that are dispersed in the matrix resin and that include a conductive polymer. The matrix resin is a matrix that allows a plurality of conductive domains to be dispersed in and fixed to the temperature-sensitive film.

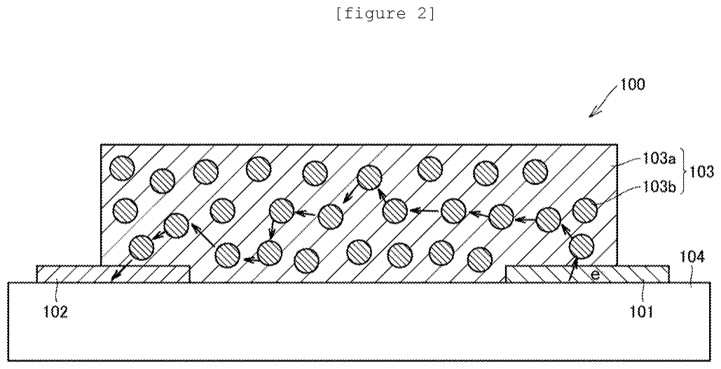

FIG. 2 is a schematic cross-sectional view illustrating one example of the temperature sensor element. A temperature sensor element 100 illustrated in FIG. 2 includes a temperature-sensitive film 103 including a matrix resin 103a and a plurality of conductive domains 103b dispersed in the matrix resin 103a.

The conductive domains 103b refer to a plurality of regions in the temperature-sensitive film 103 included in the temperature sensor element, which are dispersed in the matrix resin 103a and which contribute to electron transfer.

The conductive domains 103b include a conductive polymer including a conjugated polymer and a dopant, and are preferably constituted by a conductive polymer.

The plurality of conductive domains 103b including the conductive polymer can be dispersed in the matrix resin 103a, thereby allowing the distance between the conductive domains to be increased to some extent. Thus, the electric resistance detected by the temperature sensor element can be any electric resistance mainly derived from hopping conduction (electron transfer indicated by an arrow in FIG. 2) between the conductive domains. Such hopping conduction is highly dependent on the temperature, as can be understood from a variable range hopping conduction model (Mott-VRH model). Accordingly, such hopping conduction can be dominant to result in an enhancement in temperature dependence of the electric resistance value exhibited by the temperature-sensitive film 103.

The plurality of conductive domains 103b including the conductive polymer are dispersed in the matrix resin 103a, resulting in tendency to obtain a temperature sensor element excellent in repeating stability of the electric resistance value.

The plurality of conductive domains 103b including the conductive polymer are dispersed in the matrix resin 103a, resulting in a tendency to obtain a temperature sensor element that not only hardly causes defects such as cracks to occur in the temperature-sensitive film 103 in use of the temperature sensor element, but also can allow the dopant to be prevented from being desorbed, and thus has such a temperature-sensitive film 103 excellent in stability over time.

Examples of the matrix resin 103a include a cured product of an active energy ray-curable resin, a cured product of a thermosetting resin, and a thermoplastic resin. In particular, a thermoplastic resin is preferably used. The matrix resin 103a is preferably one that is hardly affected by water and/or heat from the viewpoint that the influence of water and/or heat from the outside on hopping conduction between the conductive domains 103b is more reduced.

The thermoplastic resin is not particularly limited, and examples thereof include polyolefin-based resins such as polyethylene and polypropylene; polyester-based resins such as polyethylene terephthalate; polycarbonate-based resins; (meth)acrylic resins; cellulose-based resins; polystyrene-based resins; polyvinyl chloride-based resins; acrylonitrile-butadiene-styrene-based resins; acrylonitrile-styrene-based resins; polyvinyl acetate-based resins; polyvinylidene chloride-based resins; polyamide-based resins; polyacetal-based resins; modified polyphenylene ether-based resins; polysulfone-based resins; polyethersulfone-based resins; polyarylate-based resins; and polyimide-based resins such as polyimide and polyamideimide.

The matrix resin 103a may be used singly or in combinations of two or more kinds thereof.

In particular, the matrix resin 103a is preferably high in polymer packing properties (also referred to as “molecular packing properties”). Such a matrix resin 103a high in molecular packing properties is used to thereby enable penetration of moisture into the temperature-sensitive film 103 to be effectively suppressed. Such suppression of penetration of moisture into the temperature-sensitive film 103 can enhance repeating stability of the electric resistance value of the temperature sensor element. Such suppression can also contribute to suppression of deterioration in measurement accuracy as indicated in the following 1) and 2).

1) If moisture is diffused in the temperature-sensitive film 103, an ion channel with water tends to be formed to result in an increase in electric conductivity due to ion conduction or the like. Such an increase in electric conductivity due to ion conduction or the like can cause a thermistor-type temperature sensor element that detects the change in temperature, as the electric resistance value, to be deteriorated in measurement accuracy.

2) If moisture is diffused in the temperature-sensitive film 103, the matrix resin 103a tends to be swollen to result in an increase in distance between the conductive domains 103b. This can lead to an increase in electric resistance value detected by the temperature sensor element, resulting in deterioration in measurement accuracy.

Such molecular packing properties are based on intermolecular interaction. Accordingly, one solution to enhance molecular packing properties of the matrix resin 103a is to introduce a functional group or moiety that easily results in intermolecular interaction, into a polymer chain.

Examples of the functional group or moiety include functional groups each capable of forming a hydrogen bond, such as a hydroxyl group, a carboxyl group, and an amino group, and functional groups or moieties (for example, moieties such as an aromatic ring) each capable of allowing π-π stacking interaction to occur.

In particular, in a case where a polymer capable of allowing π-π stacking interaction to occur is used in the matrix resin 103a, packing due to π-π stacking interaction is easily uniformly extended to the entire molecule and thus penetration of moisture into the temperature-sensitive film 103 can be more effectively suppressed.

In a case where a polymer capable of allowing π-π stacking interaction to occur is used in the matrix resin 103a, a moiety allowing intermolecular interaction to occur is hydrophobic and thus penetration of moisture into the temperature-sensitive film 103 can be more effectively suppressed.

A crystalline resin and a liquid crystalline resin also each have a highly ordered structure, and thus are each suitable as the matrix resin 103a high in molecular packing properties.

One resin preferably used as the matrix resin 103a is a polyimide-based resin from the viewpoint of heat resistance of the temperature-sensitive film 103, film formability of the temperature-sensitive film 103, and the like. Such a polyimide-based resin preferably includes an aromatic ring and more preferably includes an aromatic ring in a main chain because π-π stacking interaction easily occurs.

The polyimide-based resin can be obtained by, for example, reacting a diamine and a tetracarboxylic acid, or reacting an acid chloride in addition to them. The diamine and the tetracarboxylic acid here also include respective derivatives. The “diamine” simply designated herein means any diamine and any derivative thereof, and the “tetracarboxylic acid” simply designated herein also means any derivative thereof again.

The diamine and the tetracarboxylic acid may be each used singly or in combinations of two or more kinds thereof.

Examples of the diamine include diamine and diaminodisilane, and preferably diamine.

Examples of the diamine include an aromatic diamine, an aliphatic diamine, or a mixture thereof, and preferably include an aromatic diamine. The aromatic diamine can be used to provide a polyimide-based resin where π-π stacking can be made.

The aromatic diamine refers to a diamine where an amino group is directly bound to an aromatic ring, and the structure thereof may partially include an aliphatic group, an alicyclic group or other substituent. The aliphatic diamine refers to a diamine where an amino group is directly bound to an aliphatic group or an alicyclic group, and the structure thereof may partially include an aromatic group or other substituent.

An aliphatic diamine having an aromatic group in a portion of the structure can also be used to provide a polyimide-based resin where π-π stacking can be made.

Examples of the aromatic diamine include phenylenediamine, diaminotoluene, diaminobiphenyl, bis(aminophenoxy)biphenyl, diaminonaphthalene, diaminodiphenyl ether, bis[(aminophenoxy)phenyl]ether, diaminodiphenyl sulfide, bis[(aminophenoxy)phenyl]sulfide, diaminodiphenyl sulfone, bis[(aminophenoxy)phenyl]sulfone, diaminobenzophenone, diaminodiphenylmethane, bis[(aminophenoxy)phenyl]methane, bisaminophenylpropane, bis[(aminophenoxy)phenyl]propane, bisaminophenoxybenzene, bis[(amino-α,α′-dimethylbenzyl)]benzene, bisaminophenyldiisopropylbenzene, bisaminophenylfluorene, bisaminophenylcyclopentane, bisaminophenylcyclohexane, bisaminophenylnorbornane, bisaminophenyladamantane, and such any compound where one or more hydrogen atoms of the compound are each replaced with a fluorine atom or a hydrocarbon group including a fluorine atom (trifluoromethyl group or the like).

The aromatic diamine may be used singly or in combinations of two or more kinds thereof.

Examples of the phenylenediamine include m-phenylenediamine and p-phenylenediamine.

Examples of the diaminotoluene include 2,4-diaminotoluene and 2,6-diaminotoluene.

Examples of the diaminobiphenyl include benzidine (another name: 4,4′-diaminobiphenyl), o-tolidine, m-tolidine, 3,3′-dihydroxy-4,4′-diaminobiphenyl, 2,2-bis(3-amino-4-hydroxyphenyl)propane (BAPA), 3,3′-dimethoxy-4,4′-diaminobiphenyl, 3,3′-dichloro-4,4′-diaminobiphenyl, 2,2′-dimethyl-4,4′-diaminobiphenyl, and 3,3′-dimethyl-4,4′-diaminobiphenyl.

Examples of the bis(aminophenoxy)biphenyl include 4,4′-bis(4-aminophenoxy)biphenyl (BAPB), 3,3′-bis(4-aminophenoxy)biphenyl, 3,4′-bis(3-aminophenoxy)biphenyl, 4,4′-bis(2-methyl-4-aminophenoxy)biphenyl, 4,4′-bis(2,6-dimethyl-4-aminophenoxy)biphenyl, and 4,4′-bis(3-aminophenoxy) biphenyl.

Examples of the diaminonaphthalene include 2,6-diaminonaphthalene and 1,5-diaminonaphthalene.

Examples of the diaminodiphenyl ether include 3,4′-diaminodiphenyl ether and 4,4′-diaminodiphenyl ether.

Examples of the bis[(aminophenoxy)phenyl]ether include bis[4-(3-aminophenoxy)phenyl]ether, bis[4-(4-aminophenoxy)phenyl]ether, bis[3-(3-aminophenoxy)phenyl]ether, bis(4-(2-methyl-4-aminophenoxy)phenyl)ether, and bis(4-(2,6-dimethyl-4-aminophenoxy)phenyl) ether.

Examples of the diaminodiphenyl sulfide include 3,3′-diaminodiphenyl sulfide, 3,4′-diaminodiphenyl sulfide, and 4,4′-diaminodiphenyl sulfide.

Examples of the bis[(aminophenoxy)phenyl]sulfide include bis[4-(4-aminophenoxy)phenyl]sulfide, bis[3-(4-aminophenoxy)phenyl] sulfide, bis[4-(3-aminophenoxy)phenyl]sulfide, bis[3-(4-aminophenoxy)phenyl]sulfide, and bis[3-(3-aminophenoxy)phenyl]sulfide.

Examples of the diaminodiphenyl sulfone include 3,3′-diaminodiphenyl sulfone, 3,4′-diaminodiphenyl sulfone, and 4,4′-diaminodiphenyl sulfone.

Examples of the bis[(aminophenoxy)phenyl]sulfone include bis[3-(4-aminophenoxy)phenyl]sulfone, bis[4-(4-aminophenyl)]sulfone, bis[3-(3-aminophenoxy)phenyl]sulfone, bis[4-(3-aminophenyl)]sulfone, bis[4-(4-aminophenoxy)phenyl]sulfone, bis[4-(2-methyl-4-aminophenoxy)phenyl]sulfone, and bis[4-(2,6-dimethyl-4-aminophenoxy)phenyl]sulfone.

Examples of the diaminobenzophenone include 3,3′-diaminobenzophenone and 4,4′-diaminobenzophenone.

Examples of the diaminodiphenylmethane include 3,3′-diaminodiphenylmethane, 3,4′-diaminodiphenylmethane, and 4,4′-diaminodiphenylmethane.

Examples of the bis[(aminophenoxy)phenyl]methane include bis[4-(3-aminophenoxy)phenyl]methane, bis[4-(4-aminophenoxy)phenyl]methane, bis[3-(3-aminophenoxy)phenyl]methane, and bis[3-(4-aminophenoxy)phenyl] methane.

Examples of the bisaminophenylpropane include 2,2-bis(4-aminophenyl)propane, 2,2-bis(3-aminophenyl)propane, 2-(3-aminophenyl)-2-(4-aminophenyl)propane, 2,2-bis(2-methyl-4-aminophenyl)propane, and 2,2-bis(2,6-dimethyl-4-aminophenyl)propane.

Examples of the bis[(aminophenoxy)phenyl]propane include 2,2-bis[4-(2-methyl-4-aminophenoxy)phenyl]propane, 2,2-bis[4-(2,6-dimethyl-4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]propane, and 2,2-bis[3-(4-aminophenoxy)phenyl] propane.

Examples of the bisaminophenoxybenzene include 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,4-bis(2-methyl-4-aminophenoxy)benzene, 1,4-bis(2,6-dimethyl-4-aminophenoxy)benzene, 1,3-bis(2-methyl-4-aminophenoxy)benzene, and 1,3-bis(2,6-dimethyl-4-aminophenoxy)benzene.

Examples of the bis(amino-α,α′-dimethylbenzyl)benzene (another name: bisaminophenyldiisopropylbenzene) include 1,4-bis(4-amino-α,α′-dimethylbenzyl)benzene (BiSAP, another name: α,α′-bis(4-aminophenyl)-1,4-diisopropylbenzene), 1,3-bis[4-(4-amino-6-methylphenoxy)-α,α′-dimethylbenzyl]benzene, α,α′-bis(2-methyl-4-aminophenyl)-1,4-diisopropylbenzene, α,α′-bis(2,6-dimethyl-4-aminophenyl)-1,4-diisopropylbenzene, α,α′-bis(3-aminophenyl)-1,4-diisopropylbenzene, α,α′-bis(4-aminophenyl)-1,3-diisopropylbenzene, α,α′-bis(2-methyl-4-aminophenyl)-1,3-diisopropylbenzene, α,α′-bis(2,6-dimethyl-4-aminophenyl)-1,3-diisopropylbenzene, and α,α′-bis(3-aminophenyl)-1,3-diisopropylbenzene.

Examples of the bisaminophenyl fluorene include 9,9-bis(4-aminophenyl)fluorene, 9,9-bis(2-methyl-4-aminophenyl)fluorene, and 9,9-bis(2,6-dimethyl-4-aminophenyl)fluorene.

Examples of the bisaminophenylcyclopentane include 1,1-bis(4-aminophenyl)cyclopentane, 1,1-bis(2-methyl-4-aminophenyl)cyclopentane, and 1,1-bis(2,6-dimethyl-4-aminophenyl)cyclopentane.

Examples of the bisaminophenylcyclohexane include 1,1-bis(4-aminophenyl)cyclohexane, 1,1-bis(2-methyl-4-aminophenyl)cyclohexane, 1,1-bis(2,6-dimethyl-4-aminophenyl)cyclohexane, and 1,1-bis(4-aminophenyl) 4-methyl-cyclohexane.

Examples of the bisaminophenylnorbornane include 1,1-bis(4-aminophenyl)norbornane, 1,1-bis(2-methyl-4-aminophenyl)norbornane, and 1,1-bis(2,6-dimethyl-4-aminophenyl)norbornane.

Examples of the bisaminophenyladamantane include 1,1-bis(4-aminophenyl)adamantane, 1,1-bis(2-methyl-4-aminophenyl)adamantane, and 1,1-bis(2,6-dimethyl-4-aminophenyl)adamantane.

Examples of the aliphatic diamine include ethylenediamine, hexamethylenediamine, polyethylene glycol bis(3-aminopropyl)ether, polypropylene glycol bis(3-aminopropyl)ether, 1,3-bis(aminomethyl)cyclohexane, 1,4-bis(aminomethyl)cyclohexane, m-xylylenediamine, p-xylylenediamine, 1,4-bis(2-amino-isopropyl)benzene, 1,3-bis(2-amino-isopropyl)benzene, isophoronediamine, norbornanediamine, siloxanediamines, and such any compound where one or more hydrogen atoms of the compound are each replaced with a fluorine atom or a hydrocarbon group including a fluorine atom (trifluoromethyl group or the like).

The aliphatic diamine may be used singly or in combinations of two or more kinds thereof.

Examples of the tetracarboxylic acid include tetracarboxylic acid, tetracarboxylic acid esters, and tetracarboxylic dianhydride, and preferably include tetracarboxylic dianhydride.

Examples of the tetracarboxylic dianhydride include tetracarboxylic dianhydrides such as pyromellitic dianhydride, 3,3′,4,4′-benzophenonetetracarboxylic dianhydride, 1,4-hydroquinonedibenzoate-3,3′,4,4′-tetracarboxylic dianhydride, 3,3′,4,4′-biphenyltetracarboxylic dianhydride, 3,3′,4,4′-diphenyl ether tetracarboxylic dianhydride (ODPA), 1,2,4,5-cyclohexanetetracarboxylic dianhydride (HPMDA), 1,2,3,4-cyclobutanetetracarboxylic dianhydride, 1,2,4,5-cyclopentanetetracarboxylic dianhydride, bicyclo[2,2,2]oct-7-ene-2,3,5,6-tetracarboxylic dianhydride, 2,3,3′,4′-biphenyltetracarboxylic dianhydride, 3,3′,4,4′-benzophenonetetracarboxylic dianhydride, 4,4-(p-phenylenedioxy)diphthalic dianhydride, and 4,4-(m-phenylenedioxy)diphthalic dianhydride;

2,2-bis(3,4-dicarboxyphenyl)propane, 2,2-bis(2,3-dicarboxyphenyl)propane, bis(3,4-dicarboxyphenyl)sulfone, bis(3,4-dicarboxyphenyl)ether, bis(2,3-dicarboxyphenyl) ether, 1,1-bis(2,3-dicarboxyphenyl)ethane, bis(2,3-dicarboxyphenyl)methane, and bis(3,4-dicarboxyphenyl)methane; and such any compound where one or more hydrogen atoms of the compound are each replaced with a fluorine atom or a hydrocarbon group including a fluorine atom (trifluoromethyl group or the like).

The tetracarboxylic dianhydride may be used singly or in combinations of two or more kinds thereof.

Examples of the acid chloride include respective acid chlorides of a tetracarboxylic acid compound, a tricarboxylic acid compound, and a dicarboxylic acid compound, and in particular, an acid chloride of a dicarboxylic acid compound is preferably used. Examples of the acid chloride of a dicarboxylic acid compound include 4,4′-oxybis(benzoyl chloride) [OBBC] and terephthaloyl dichloride (TPC).

In a case where the matrix resin 103a includes a fluorine atom, penetration of moisture into the temperature-sensitive film 103 tends to be capable of being more effectively suppressed. A polyimide-based resin including a fluorine atom can be prepared by using one where at least any one of a diamine and a tetracarboxylic acid for use in preparation includes a fluorine atom.

One example of such a diamine including a fluorine atom is 2,2′-bis(trifluoromethyl)benzidine (TFMB). One example of such a tetracarboxylic acid including a fluorine atom is 4,4′-(1,1,1,3,3,3-hexafluoropropane-2,2-diyl)diphthalic dianhydride (6FDA).

The weight average molecular weight of the polyimide-based resin is preferably 20000 or more, more preferably 50000 or more, and preferably 1000000 or less, more preferably 500000 or less.

The weight average molecular weight can be determined with a size exclusion chromatography apparatus.

The matrix resin 103a preferably includes 50% by mass or more, more preferably 70% by mass or more, further preferably 90% by mass or more, still further preferably 95% by mass or more, particularly preferably 100% by mass of the polyimide-based resin, based on the total of the resin component(s) of 100% by mass constituting the matrix resin. The polyimide-based resin is preferably a polyimide-based resin including an aromatic ring, more preferably, a polyimide-based resin including an aromatic ring and a fluorine atom.

The content of the matrix resin 103a is preferably 10% by mass or more, more preferably 20% by mass or more, further preferably 30% by mass or more, still further preferably 40% by mass or more based on the mass of the temperature-sensitive film 103 of 100% by mass. The content of the matrix resin 103a is preferably 90% by mass or less, more preferably 80% by mass or less, further preferably 70% by mass or less based on the mass of the temperature-sensitive film 103 of 100% by mass, from the viewpoint of a reduction in power consumption of the temperature sensor element and from the viewpoint of a normal operation of the temperature sensor element.

The content of the matrix resin 103a in the polymer composition for a temperature-sensitive film, based on the solid component of 100% by mass in the composition, is in the same range as the content range based on the mass of the temperature-sensitive film 103 of 100% by mass.

A high content of the matrix resin 103a results in a tendency to increase the electric resistance, sometimes leading to an increase in current necessary for measurement and thus a remarkable increase in power consumption. A high content of the matrix resin 103a also sometimes provides no communication between the electrodes. A high content of the matrix resin 103a sometimes causes Joule heat to be generated depending on the current flowing, and also sometimes makes temperature measurement by itself difficult.

[3-3] Configuration of Temperature-Sensitive Film

The temperature-sensitive film 103 preferably has a configuration that includes the matrix resin 103a and the plurality of conductive domains 103b dispersed in the matrix resin 103a. The conductive domains 103b include a conductive polymer including a conjugated polymer and a dopant, and are preferably constituted by a conductive polymer.

The total content of the conjugated polymer and the dopant in the temperature-sensitive film 103 is preferably 95% by mass or less based on 100% by mass of the total amount of the matrix resin 103a, the conjugated polymer and the dopant, from the viewpoint of effective suppression of penetration of moisture into the temperature-sensitive film 103. The content is more preferably 90% by mass or less, further preferably 80% by mass or less, still further preferably 70% by mass or less, particularly preferably 60% by mass or less. If the total content of the conjugated polymer and the dopant is more than 95% by mass, the content of the matrix resin 103a in the temperature-sensitive film 103 is low, resulting in a tendency to deteriorate the effect of suppressing penetration of moisture into the temperature-sensitive film 103.

The total content of the conjugated polymer and the dopant in the temperature-sensitive film 103 is preferably 5% by mass or more based on 100% by mass of the total amount of the matrix resin 103a, the conjugated polymer and the dopant, from the viewpoint of a reduction in power consumption of the temperature sensor element and from the viewpoint of a normal operation of the temperature sensor element. The content is more preferably 10% by mass or more, further preferably 15% by mass or more, still further preferably 20% by mass or more.

A low total content of the conjugated polymer and the dopant results in a tendency to increase the electric resistance, sometimes leading to an increase in current necessary for measurement and thus a remarkable increase in power consumption. A low total content of the conjugated polymer and the dopant also sometimes provides no communication between the electrodes. A low total content of the conjugated polymer and the dopant sometimes causes Joule heat to be generated depending on the current flowing, and also sometimes makes temperature measurement by itself difficult. Accordingly, the total content of the conjugated polymer and the dopant, which enables the conductive polymer to be formed, is preferably in the above range.

The thickness of the temperature-sensitive film 103 is not particularly limited, and is, for example, 0.3 μm or more and 50 μm or less. The thickness of the temperature-sensitive film 103 is preferably 0.3 μm or more and 40 μm or less from the viewpoint of flexibility of the temperature sensor element.

[3-4] Production of Temperature-Sensitive Film

The temperature-sensitive film 103 is obtained by stirring and mixing the conjugated polymer, the dopant, a solvent, and the matrix resin optionally used (for example, thermoplastic resin) to thereby prepare a polymer composition for a temperature-sensitive film, and forming the composition into a film. Examples of the film formation method include a method involving applying the polymer composition for a temperature-sensitive film onto the substrate 104, and then drying and, if necessary, heat-treating the resultant. The method of applying the polymer composition for a temperature-sensitive film is not particularly limited, and examples include a spin coating method, a screen printing method, an ink-jet printing method, a dip coating method, an air knife coating method, a roll coating method, a gravure coating method, a blade coating method, and a dropping method.

In a case where the matrix resin 103a is formed from an active energy ray-curable resin or a thermosetting resin, a curing treatment is further applied. In a case where an active energy ray-curable resin or a thermosetting resin is used, no solvent may be required to be added to the polymer composition for a temperature-sensitive film, and in this case, no drying treatment is also required.

The polymer composition for a temperature-sensitive film usually allows the conjugated polymer and the dopant to form conductive polymer domains (conductive domains). The polymer composition for a temperature-sensitive film preferably includes the matrix resin because such conductive domains are more dispersed in the composition than those in a case where no matrix resin is included, and conduction between such conductive domains easily serves as hopping conduction and the electric resistance value can be accurately detected.

In a case where the polymer composition for a temperature-sensitive film includes the matrix resin, the content of the matrix resin based on the total amount of the composition (excluding the solvent) is preferably substantially the same as the content of the matrix resin relative to the conjugated polymer in the temperature-sensitive film 103 formed from the composition.

The content of each component included in the polymer composition for a temperature-sensitive film corresponds to the content of each component relative to the total of each component in the polymer composition for a temperature-sensitive film, excluding the solvent, and is preferably substantially the same as the content of each component in the temperature-sensitive film 103 formed from the polymer composition for a temperature-sensitive film.

The solvent included in the polymer composition for a temperature-sensitive film is preferably a solvent that can dissolve the conjugated polymer, the dopant, and the matrix resin optionally used, from the viewpoint of film formability.

The solvent is preferably selected depending on, for example, the solubilities of the conjugated polymer and dopant used, and the matrix resin optionally used, in the solvent.

Examples of such a usable solvent include N-methyl-2-pyrrolidone, N,N-dimethylacetamide, N,N-diethylacetamide, N,N-dimethylformamide, N,N-diethylformamide, N-methylcaprolactam, N-methylformamide, N,N,2-trimethylpropionamide, hexamethylphosphoramide, tetramethylenesulfone, dimethylsulfoxide, m-cresol, phenol, p-chlorophenol, 2-chloro-4-hydroxytoluene, diglyme, triglyme, tetraglyme, dioxane, γ-butyrolactone, dioxolane, cyclohexanone, cyclopentanone, 1,4-dioxane, ε-caprolactam, dichloromethane, and chloroform.

The solvent may be used singly or in combinations of two or more kinds thereof.

The polymer composition for a temperature-sensitive film may include one or more additives such as an antioxidant, a flame retardant, a plasticizer, and an ultraviolet absorber.

The total content of the conjugated polymer, the dopant and the matrix resin in the polymer composition for a temperature-sensitive film is preferably 90% by mass or more based on the solid content (all components other than the solvent) of the polymer composition for a temperature-sensitive film, of 100% by mass. The total content is more preferably 95% by mass or more, further preferably 98% by mass or more, and may be 100% by mass.

[4] Temperature Sensor Element

The temperature sensor element can include any constituent component other than the above constituent components. Examples of such other constituent component include those commonly used for temperature sensor elements, such as an electrode, an insulation layer, and a sealing layer that seals the temperature-sensitive film.

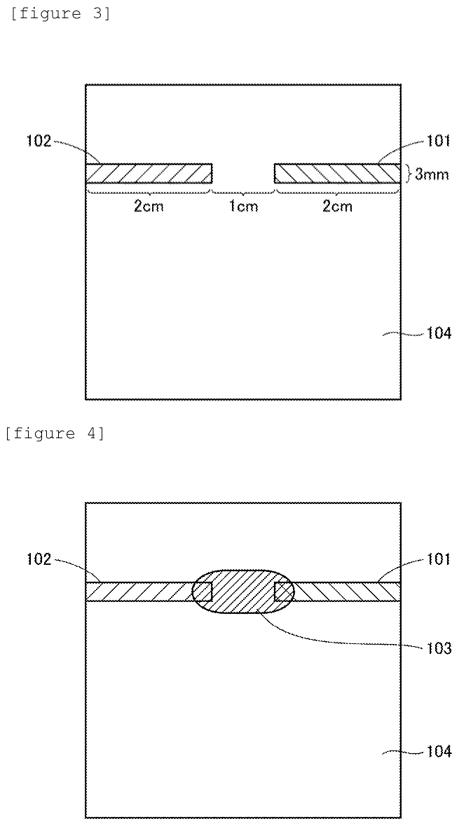

The temperature sensor element including the temperature-sensitive film is excellent in repeating stability of the electric resistance value. The repeating stability of the electric resistance value can be evaluated according to the following method. First, a pair of Au electrodes is formed on one surface of a glass substrate, as illustrated in FIG. 3, and thereafter, the temperature-sensitive film is formed so as to be in contact with both the electrodes, thereby forming the temperature sensor element, as illustrated in FIG. 4.

Next, the pair of Au electrodes of the temperature sensor element and a commercially available digital multimeter are connected with a lead wire or the like, and the temperature of the temperature sensor element is adjusted by using a commercially available Peltier temperature controller. Thereafter, the average electric resistance value at each temperature of a plurality of temperatures is measured. In Examples, the measurement is performed at eight points of 10° C., 20° C., 30° C., 40° C., 50° C., 60° C., 70° C. and 80° C., but is not limited thereto and is preferably performed at five points or more.

The average electric resistance value at each temperature is determined as follows. First, the temperature of the temperature sensor element is adjusted to 10° C., this temperature is retained for a certain time (1 hour in Examples), and the average with respect to the electric resistance value for such 1 hour is measured as the average electric resistance value at 10° C. Next, the temperature of the temperature sensor element is sequentially raised from 10° C., the temperature raised is retained for a certain time in the same manner, and the average with respect to the electric resistance value for this certain time is measured as the average electric resistance value at the temperature. Such an operation is performed at each measurement temperature in the same manner. The above operation is defined as one cycle, and is continuously performed for five cycles. Herein, each test at the 2^{nd} and later cycles is performed by again adjusting the temperature of the temperature sensor element to 10° C. and performing the same operation as in the 1^{st} cycle.

The rate of change r (%) in electric resistance value is calculated according to the following expression with the average electric resistance value R1 at the 1st cycle at 10° C. and the average electric resistance value R5 at the 5th cycle at 10° C.

r (%)=100×(|R1−R5|/R1)

It can be said that a lower rate of change r (%) corresponds to higher repeating stability of the electric resistance value exhibited by the temperature sensor element, and thus the rate is preferably 20% or less. The rate of change r is more preferably 19% or less, further preferably 15% or less.

### EXAMPLES

Hereinafter, the present invention is further specifically described with reference to Examples, but the present invention is not limited to these Examples at all. In Examples, “%” and “part(s)” representing any content or amount of use are on a mass basis, unless particularly noted.

### Production Example 1: Preparation of Dedoped Polyaniline

A dedoped polyaniline was prepared by preparing and dedoping a polyaniline doped with hydrochloric acid, as shown in the following [1] and [2].

[1] Preparation of Polyaniline Doped with Hydrochloric Acid

A first aqueous solution was prepared by dissolving 5.18 g of aniline hydrochloride (manufactured by Kanto Kagaku) in 50 mL of water. A second aqueous solution was prepared by dissolving 11.42 g of ammonium persulfate (manufactured by Fujifilm Wako Pure Chemical Corporation) in 50 mL of water.

Next, the first aqueous solution was stirred using a magnetic stirrer at 400 rpm for 10 minutes with the temperature being regulated at 35° C., and thereafter, the second aqueous solution was dropped to the first aqueous solution at a dropping speed of 5.3 mL/min under stirring at the same temperature. After the dropping, a reaction was further allowed to occur for 5 hours with a reaction liquid being kept at 35° C., and thus a solid was precipitated in the reaction liquid.

Thereafter, the reaction liquid was filtered by suction with a paper filter (second kind for chemical analysis in JIS P 3801), and the resulting solid was washed with 200 mL of water. Thereafter, the solid was washed with 100 mL of 0.2 M hydrochloric acid and then 200 mL of acetone, and thereafter dried in a vacuum oven, thereby obtaining a polyaniline doped with hydrochloric acid, represented by the following formula (1).

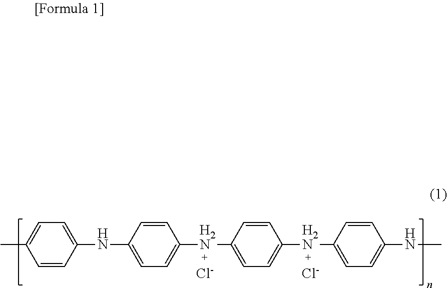

[2] Preparation of Dedoped Polyaniline

Four g of the polyaniline doped with hydrochloric acid, obtained in [1], was dispersed in 100 mL of 12.5% by mass ammonia water and the resultant was stirred with a magnetic stirrer for about 10 hours, thereby precipitating a solid in a reaction liquid.

Thereafter, the reaction liquid was filtered by suction with a paper filter (second kind for chemical analysis in JIS P 3801), and the resulting solid was washed with 200 mL of water and then 200 mL of acetone. Thereafter, the solid was dried in vacuum at 50° C., thereby obtaining a dedoped polyaniline represented by the following formula (2). The dedoped polyaniline was dissolved in N-methylpyrrolidone (NMP; Tokyo Chemical Industry Co., Ltd.) so that the concentration was 5% by mass, thereby preparing a solution of the dedoped polyaniline (conjugated polymer).

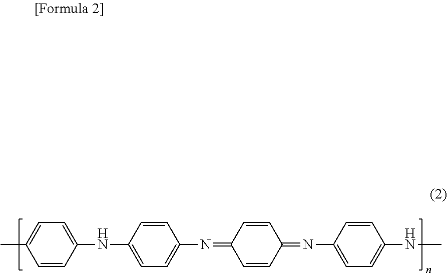

### Production Example 2: Preparation of Matrix Resin 1

A powder of polyimide having a repeating unit represented by the following formula (5) was produced using 2,2′-bis(trifluoromethyl)benzidine (TFMB) represented by the following formula (3), as a diamine, and 4,4′-(1,1,1,3,3,3-hexafluoropropane-2,2-diyl)diphthalic dianhydride (6FDA) represented by the following formula (4), as a tetracarboxylic dianhydride, according to the description in Example 1 of International Publication No. WO 2017/179367.

The powder was dissolved in propylene glycol 1-monomethyl ether 2-acetate so that the concentration was 8% by mass, thereby preparing a solution of polyimide.

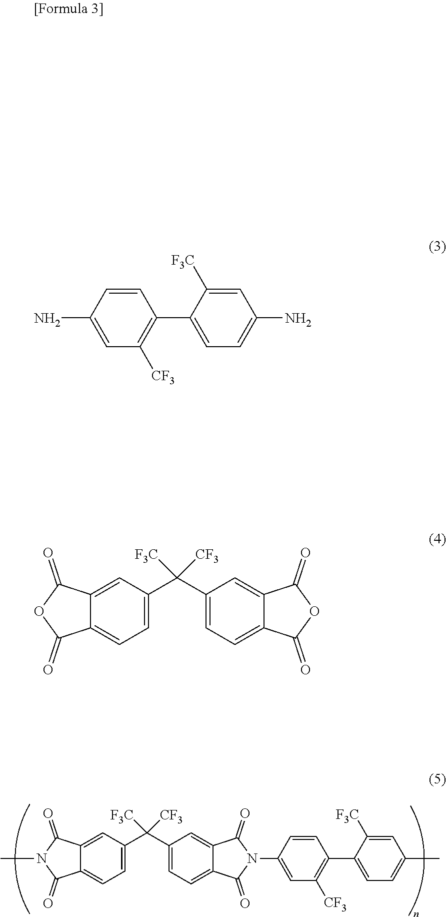

### Example 1

[1] Preparation of Polymer Composition for Temperature-Sensitive Film

A polymer composition (solid content 5% by mass) for a temperature-sensitive film was prepared by mixing 1.000 g of the solution of dedoped polyaniline prepared in Production Example 1, 1.656 g of NMP (Tokyo Chemical Industry Co., Ltd.), 1.458 g of the solution of polyimide as a matrix resin, prepared in Production Example 2, and 0.041 g of 2-(2-pyridyl)ethanesulfonic acid (Tokyo Chemical Industry Co., Ltd.) as a dopant. The dopant was used in an amount of 1.6 mol based on 1 mol of the dedoped polyaniline.

[2] Production of Temperature Sensor Element

The production procedure of a temperature sensor element is described with reference to FIG. 3 and FIG. 4.

A pair of rectangular Au electrodes of 2 cm in length×3 mm in width was formed on one surface of a glass substrate (“Eagle XG” manufactured by Corning Incorporated) of a 5-cm square by sputtering using Ioncoater (“IB-3” manufactured by Eiko Corporation), with reference to FIG. 3.

The thickness of each of the Au electrodes according to cross section observation with a scanning electron microscope (SEM) was 200 nm.

Next, 200 μL of the polymer composition for a temperature-sensitive film, prepared in [1], was dropped between the pair of Au electrodes formed on the glass substrate, with reference to FIG. 4. A film of the polymer composition for a temperature-sensitive film, formed by the dropping, was in contact with both the electrodes. Thereafter, the film was subjected to a drying treatment at 50° C. under normal pressure for 2 hours and then at 50° C. under vacuum for 2 hours, and thereafter a heat treatment at 100° C. for about 1 hour, thereby forming a temperature-sensitive film and producing a temperature sensor element. The thickness of the temperature-sensitive film was measured with Dektak KXT (manufactured by Bruker), and was 30 μm.

### Example 2

A polymer composition (solid content 5% by mass) for a temperature-sensitive film was prepared by mixing 1.000 g of the solution of dedoped polyaniline prepared in Production Example 1, 1.748 g of NMP (Tokyo Chemical Industry Co., Ltd.), 1.458 g of the solution of polyimide as a matrix resin, prepared in Production Example 2, and 0.046 g of isoquinoline-5-sulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

### Example 3

A polymer composition (solid content 5% by mass) for a temperature-sensitive film was prepared by mixing 1.000 g of the solution of dedoped polyaniline prepared in Production Example 1, 2.128 g of NMP (Tokyo Chemical Industry Co., Ltd.), 1.458 g of the solution of polyimide as a matrix resin, prepared in Production Example 2, and 0.066 g of nonafluoro-1-butanesulfonic acid (manufactured by Fujifilm Wako Pure Chemical Corporation) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

### Example 4

A polymer composition (solid content 5% by mass) for a temperature-sensitive film was prepared by mixing 1.000 g of the solution of dedoped polyaniline prepared in Production Example 1, 1.610 g of NMP (Tokyo Chemical Industry Co., Ltd.), 1.458 g of the solution of polyimide as a matrix resin, prepared in Production Example 2, and 0.039 g of 4-fluoro-benzenesulfonic acid (manufactured by Fujifilm Wako Pure Chemical Corporation) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

### Example 5

A polymer composition (solid content 5% by mass) for a temperature-sensitive film was prepared by mixing 1.000 g of the solution of dedoped polyaniline prepared in Production Example 1, 1.535 g of NMP (Tokyo Chemical Industry Co., Ltd.), 1.458 g of the solution of polyimide as a matrix resin, prepared in Production Example 2, and 0.035 g of benzenesulfonic acid (manufactured by Sigma-Aldrich Co. LLC) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

### Comparative Example 1

A polymer composition (solid content 5% by mass) was prepared by mixing 1.000 g of the solution of dedoped polyaniline prepared in Production Example 1, 0.875 g of NMP (Tokyo Chemical Industry Co., Ltd.), and 1.458 g of the solution of polyimide as a matrix resin, prepared in Production Example 2.

Next, a glass substrate provided with a pair of Au electrodes produced by the same method as in [2] of Example 1 was prepared, and 200 μL of the polymer composition prepared above was dropped between the pair of Au electrodes. A film of the polymer composition, formed by the dropping, was in contact with both the electrodes. Thereafter, the film was subjected to a drying treatment at 50° C. under normal pressure for 2 hours and at 50° C. under vacuum for 2 hours, and thereafter a heat treatment at 100° C. for about 1 hour.

Thereafter, the whole glass substrate was immersed in 50 mL of 0.2 mol/L hydrochloric acid (manufactured by Kanto Kagaku) for 12 hours, and subjected to doping of polyaniline. After the immersion, the resultant was well washed with pure water, and moisture adsorbed was removed by use of a waste cloth and an air gun. Thereafter, the resultant was subjected to a drying treatment at 25° C. under vacuum for 1 hour, thereby producing a temperature sensor element. The thickness of the temperature-sensitive film was measured in the same manner as in Example 1, and was 30 μm.

The type and the molecular volume of each dopant used in Examples 1 to 5 and Comparative Example 1 are shown in Table 1.

The molecular volume of the dopant was determined based on the molecular structure, according to DFT (Density Functional Theory; B3LYP/6-31G) calculation using a quantum chemistry calculation program “Gaussian 16” manufactured by Hulinks Inc.

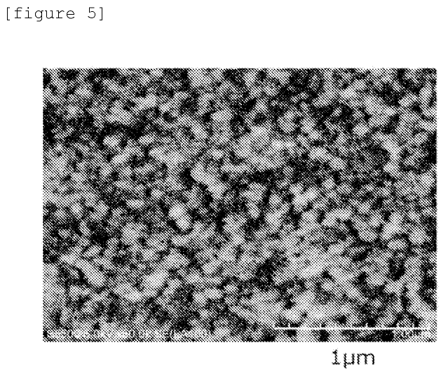

FIG. 5 illustrates a SEM photograph imaging a cross section of the temperature-sensitive film in the temperature sensor element produced in Example 1. A white-photographed portion corresponded to conductive domains dispersed in the matrix resin.

[Evaluation of Temperature Sensor Element]

The repeating stability of the electric resistance value exhibited by the temperature sensor element was evaluated by the following evaluation test.

The pair of Au electrodes in the temperature sensor element and a digital multimeter (“B35T+” manufactured by OWON Japan) were connected with a lead wire. The temperature of the temperature sensor element was adjusted by use of a Peltier temperature controller (“HMC-10F-0100” manufactured by Hayashi-Repic Co., Ltd.), and the average electric resistance value at each temperature of 10° C., 20° C., 30° C., 40° C., 50° C., 60° C., 70° C. and 80° C. was measured.

The average electric resistance value at each temperature was measured according to the following method. First, the temperature of the temperature sensor element was adjusted to 10° C. by use of the Peltier temperature controller, and this temperature was retained for 1 hour. The average with respect to the electric resistance value for such 1 hour was measured as the average electric resistance value at 10° C. Next, the temperature of the temperature sensor element was adjusted to 20° C., and this temperature was retained for 1 hour. The average with respect to the electric resistance value for such 1 hour was measured as the average electric resistance value at 20° C. The same manner was performed with respect to each temperature other than 10° C. and 20° C., and the average with respect to the electric resistance value for a retention time of 1 hour was measured as the average electric resistance value at such each temperature. The above operation was defined as one cycle.

The test at the 2^{nd} cycle was performed by again adjusting the temperature of the temperature sensor element to 10° C. and performing the same operation as in the 1^{st} cycle. Measurement was performed for five cycles with the test being continued.

The rate of change r (%) in electric resistance value was determined according to the following expression with the average electric resistance value R1 at the 1^{st} cycle at 10° C. and the average electric resistance value R5 at the 5th cycle at 10° C. The results are shown in Table 1. It can be said that a lower rate of change r (%) corresponds to higher repeating stability of the electric resistance value exhibited by the temperature sensor element, and thus the rate is desirably 20% or less.

r (%)=100×(|R1−R5|/R1)

The temperature sensor element of Comparative Example 1 could not be tested until the 5th cycle because the temperature-sensitive film was cracked in the course of the evaluation test.

TABLE 1

| | Dopant | | Rate of change |
|---|---|---|---|
| | | Molecular | r (%) in electric |
| | | volume | resistance |
| | Type | (nm³) | value |
| Example 1 | 2-(2-Pyridyl) | 0.246 | 55 |
| | ethanesulfonic | | |
| | acid | | |
| Example 2 | Isoquinoline- | 0.220 | 12.3 |
| | 5-sulfonic | | |
| | acid | | |
| Example 3 | Nonafluoro-1- | 0.206 | 14.3 |
| | butanesulfonic | | |
| | acid | | |
| Example 4 | 4-Fluoro- | 0.186 | 18.6 |
| | benzenesulfonic | | |
| | acid | | |
| Example 5 | Benzenesulfonic | 0.171 | 16.0 |
| | acid | | |
| Comparative | Hydrochloric | 0.039 | — |
| Example 1 | acid | | |

### REFERENCE SIGNS LIST

100 temperature sensor element, 101 first electrode, 102 second electrode, 103 temperature-sensitive film, 103a matrix resin, 103b conductive domain, 104 substrate.

1. A temperature sensor element comprising a pair of electrodes and a temperature-sensitive film disposed in contact with the pair of electrodes, wherein
the temperature-sensitive film comprises a conductive polymer,
the conductive polymer comprises a conjugated polymer and a dopant, and
the dopant comprises a dopant having a molecular volume of 0.08 nm³ or more.

2. The temperature sensor element according to claim 1, wherein
the temperature-sensitive film comprises a matrix resin and a plurality of conductive domains contained in the matrix resin, and
the conductive domains comprise the conductive polymer.

3. The temperature sensor element according to claim 2, wherein the matrix resin comprises a polyimide-based resin.

4. The temperature sensor element according to claim 3, wherein the polyimide-based resin comprises an aromatic ring.

5. The temperature sensor element according to claim 1, wherein the conjugated polymer is a polyaniline-based polymer.
